(19) United States
(12) Patent Application Publication
(10) Pub. No.: US 2008/0177653 A1
(43) Pub. Date: Jul. 24, 2008

(54) System and method for enabling service providers to create real-time reverse auctions for location based services

(76) Inventors: David Famolari, Stewartsville, NJ (US); Shoshana K. Loeb, Philadelphia, PA (US)

Correspondence Address: TELCORDIA TECHNOLOGIES, INC., ONE TELCORDIA DRIVE 5G116, PISCATAWAY, NJ, 08854-4157, US

(21) Appl. No.: 12/009,475

(22) Filed: Jan. 18, 2008

Related U.S. Application Data
(60) Provisional application No. 60/881,709, filed on Jan. 22, 2007.

(51) Int. Cl. G06Q 30/00

(52) U.S. Cl. 705/37

(57) ABSTRACT

A system and method facilitates the matching of service providers based on certain criteria such as, but not limited to, location of the provider in relation to a customer location, customer requests based on the location of the customer, the type of service requested and other possible attributes such as customer profile, customer past behavior and preferences and service price and quality. Service providers create real-time reverse auctions by using advanced data collection, filtering and disseminating algorithms. In addition, market-makers can provide value-added services, such as real-time traffic conditions and route planning, to their local affiliates. Such a scheme can allow market-makers to economically service customer requests by leveraging the real-time conditions and circumstances of their vast network of local service affiliates. Open competition will drive down prices for these services and increase revenues for the market-makers who will be able to service customer requests at the best prices available. This system will also benefit local service affiliates by notifying them and allowing them to compete for a broader number of service requests. A feedback mechanism will also encourage superior customer service since affiliates will want to ensure that they are considered for more jobs.

### CROSS REFERENCE TO RELATED APPLICATION

The present invention claims the benefit of U.S. provisional patent application 60/881,709 filed Jan. 22, 2007, the entire content and disclosure of which is incorporated herein by reference.

### FIELD OF THE INVENTION

The present invention relates generally to a system and method for enabling service providers to create real-time reverse auctions for location based services. Specifically, the invention concerns matching of service providers to customers and more specifically to a market-maker using a system platform for matching service providers to a customer.

### BACKGROUND OF THE INVENTION

The invention concerns a system and method that facilitates the matching of service providers based on certain criteria such as, but not limited to, location of the provider in relation to a customer location, customer requests based on the location of the customer, the type of service requested and other possible attributes such as customer profile, customer past behavior and preferences and service price and quality.

The invention will described using the example of an owner or driver of a disabled vehicle seeking automotive services, but it will be understood that the invention has many other applications where an auction for the providing of services to a customer is desirable.

As an example, the system and method of the invention can enable car towing service providers to bid in real time for providing a service to the driver of a car that became stranded on area roads.

The entity that is using the platform to match local service providers to the customer is referred to as the “market-maker”.

There are economic incentives for the various parties to the transaction. Market-makers may benefit by charging a fee to service providers in order to participate in the auction and, in some case, increasing revenue due to larger profit margins. Local service providers benefit from participating in the program by gaining access to revenue generating opportunities that they may not have otherwise been aware of. Furthermore, service providers who win the auction process may increase revenues through providing follow-on services for the customer.

The invention uses factors such as the specific location, customer and service information in order to allow a market-maker to create a reverse auction whereby local service providers can bid to win the opportunity of providing service corresponding to the customer's request.

Reverse auctions are those auctions where sellers compete for business opportunities, in contrast to traditional auctions where buyers compete to purchase a good or service. The goal of reverse auctions is to drive down the bidding price, while that of traditional auctions is to drive up the bidding price.

Market-makers (contracting organizations, businesses, etc.) often conduct reverse auctions to secure a business contract with a supplier at the lowest price. In such a scenario, the market-maker makes the reverse auction participants aware of a business opportunity and sets an initial or maximum price that the market-maker is willing to pay to secure that business opportunity. The auction participants then submit bids in an attempt to win the market-maker's business.

Auctions may be considered English or Dutch depending upon the nature of the starting price set by the market-maker.

In English reverse auctions, the starting bid is the highest price the market-maker is willing pay for the service, and subsequent bids are lower.

In Dutch reverse auctions, the starting price set by the market maker is low and subsequent bids are increased until an auction participant agrees to pay the bid price.

The present invention supports both types of reverse auctions.

### SUMMARY OF THE INVENTION

The present invention enables service providers to create real-time reverse auctions by using advanced data collection, filtering and disseminating algorithms. In addition, market-makers can provide value-added services, such as real-time traffic conditions and route planning, to their local affiliates. Such a system can allow market-makers to economically service customer requests by leveraging the real-time conditions and circumstances of their vast network of local service affiliates.

Open competition will drive down prices for these services and increase revenues for the market-makers who will be able to provide service in response to customer requests at the best prices available. The system will also benefit local service affiliates by notifying them and allowing them to compete for a broader number of service requests than they would otherwise be aware of.

The system can also provide for a feedback mechanism where the customer provides feedback regarding the service provided. The feedback mechanism will encourage superior customer service since affiliates will want to ensure that they are considered for more jobs. That is, low customer evaluations in the feedback will result in the service provider not being considered for future opportunities.

By using advanced algorithms to leverage the time-value of information and by applying sophisticated communication and filtering techniques, the reverse auction platform presented by this invention benefits both market-makers and local affiliates alike by enabling a higher level of dynamism and efficiency in matching service requests with service providers.

The invention will be better understood when the following description is read in conjunction with the accompanying drawings.

### BRIEF DESCRIPTION OF THE DRAWING

FIG. 1 is flow diagram of an embodiment of the invention.

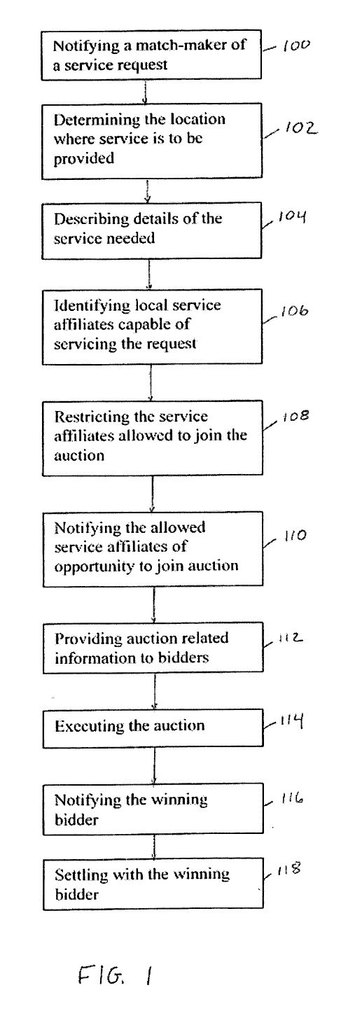

### DETAILED DESCRIPTION

An illustrative example of a system and method of the invention will now be described in connection with an automobile break down scenario. It will be understood by those skilled in the art that the invention has many other applications, in addition to an automotive break down application, where the invention is equally applicable and advantageous.

This invention concerns systems, methods and algorithms that enable market-makers to create real-time, secure, information-rich reverse auctions. While the invention generalizes to any type of service requests where a reverse auction may be appropriate, the invention will be described using a representative example of a car-towing service as illustrative of the invention throughout the following description, it being understood that the invention is not so limited.

In accordance with the present example, consider the market-maker to be a national car-towing company that uses local service affiliates to fill customer requests. The local service affiliates then compete with each other to service those customer requests. The competitive factors between local affiliates may include a number of variables, some which include price, reliability, time to service the request, favorable customer feedback, and the like.

The invention comprises several steps that enable market-makers to successfully and reliably offer real-time reverse auctions. These steps are outlined below:

1) Geographic localization and confirmation of customer's location.

2) Categorizing and indexing of customer requirements.

3) Identification of feasible local service affiliates.

4) Filtering of feasible service affiliates to candidate service affiliates.

5) Notification to candidate service affiliates.

6) Display of relevant customer request information to candidate service affiliates:
a. Initial price for bids.
b. Distance to customer and distance to desired customer final destination.
c. Real-time traffic and weather conditions for both the customer's location as well as the customer's desired (drop off point) final destination.
d. Routing information from the local service affiliate's location to the customer, from the customer's location to the customer's final destination, and from the customer final destination back to the service affiliate's location.
e. Applicable history and profile information of the customer.
f. Make and model of the car, as well as possible items and tools to carry to the location.

7) Auction execution software.
a. Mechanisms that allow the candidate service affiliates to bid.
b. Real-time data management methods that can reliably relay bid prices from auction participants to the auction platform.

8) Settlement software that finalizes a contract between the winning bidder and the market-maker.

9) Billing mechanism that allows the winning candidate affiliate and the market-maker to be paid.

10) Feedback mechanisms to allow both the customer and the service affiliate to submit feedback about the process that will be stored in a database and consulted for future service opportunities.

In the following description a system and process by which the market-maker can enable such a reverse auction is described. We will consider a representative example of a car that has broken down alongside the road and needs a tow.

Step 1

The car owner/driver calls a national car-towing company (or a national car-towing company is contacted via a roadside assistance provider such as AAA, etc.) that service is required 100. In some instances the car can directly contact a roadside assistance provider when the car is provided with equipment for detecting a breakdown of the car.

The first step in enabling the reverse auction is to determine the location of the customer 102. While the caller can specify the location, it is not uncommon for travelers to be lost or to be unable to provide specific location information.

The software platform will, in such cases, have the capability of integrating with other telecommunications platforms to confirm the caller's location. This may occur via any known method of determining mobile location such as cellular positioning (for cell phone calls), and/or reverse phone number addressing (for landline phone calls), and/or the use of a global positioning system (GPS) in the vehicle or phone. The outcome of this process will be an address, cross-street or mile-marker identification that can be used to find the customer. Alternatively, if longitude and latitude information (geographical co-ordinates) is determined, the co-ordinates can be converted to a map location.

Step 2

The caller provides details about the situation including make and model of car, symptoms the car displayed before breaking down, preferences for towing destinations (dealerships, home, work, etc.), time-frame commitments, and the like 104.

This information is captured and indexed into a networked software platform. Indexing the information in a common format, such as XML or RDF, allows a standard method for the information to be represented, queried and managed.

If this customer is already known to the system, the software platform can supplement the information with other information captured in the customer profile.

Step 3

Once a customer's location and service parameters have been captured and indexed, the market-maker can begin to identify local service affiliates that are capable of servicing the request 106. The identification problem can be formulated as a constrained optimization problem where a feasibility region can be identified.

The software, once configured and customized according to the policies of the market-maker, will be able to construct the feasibility region over the space of all possible local service affiliates 108. Those affiliates that reside within the feasibility region will be considered and those that reside outside the region will not be considered.

As an initial example, the feasibility region may be very simple. For example, the system may identify those local affiliates who are within a certain geographic range of the customer's present location, e.g., 30 miles.

As another example, if a car breaks down in New York City and the driver needs to be towed to her home in Philadelphia, the market-maker may choose to alert service providers in both the New York City and the Philadelphia areas.

In another embodiment of the invention use real-time traffic conditions and route planning algorithms are used to determine the mean time to reach the customer. In such cases the closest local affiliate may not be the affiliate that can reach the customer in the shortest amount of time. As used herein, the term “real-time” will be understood to include so-called “near real-time” information.

By incorporating real-time traffic conditions and routing algorithms, the market-maker can immediately eliminate local affiliates who may not be able to meet the customer's time constraints.

Furthermore, using live or real-time or near real-time data allows the system to dynamically adapt to changes in ways that a static system can not adapt. Distance and time to the customer are only example criteria, however, and the market-maker may identify local affiliates on the basis of their affiliation (Toyota dealers, for example) or special facilities or capabilities of a local affiliate.

The market-maker may decide to cull from the list those local service affiliates with poor recent feedback ratings or a history of billing disputes, etc. The resulting list of local service affiliates capable of servicing the customer request and satisfying any market-maker imposed policies then become the set of candidate service affiliates who will be notified of the service opportunity and will be given the opportunity to participate in the auction.

Step 4

The candidate service affiliates once identified must then be notified 110. The present invention allows candidates to be notified via multiple mechanisms including via a web-based application as well as via wireless communication through SMS.

The notification will alert staff at candidate service affiliates that there is an active auction underway. The web application will then display auction details such as current price and information relevant to the customer request, including current customer location, desired drop-off point (final destination) as well as mileage and routing information 112.

The web-application can also display current traffic information to give the decision makers at the candidate service affiliates an idea of transit times, etc. Also, the application may display a recommended list of items and tools to bring to the scene that may help in diagnosing and solving the customer's car problems.

The platform is also capable of delivering notifications to candidate service affiliates via SMS. This allows those candidate affiliates who may be away from a computer or out in the field to still participate in the auction process. By delivering notifications only via the web, many candidate affiliates may miss out on revenue generating opportunities.

SMS notifications may contain less information than that contained in the web-based notifications. However the SMS notifications will contain links to a website that allow candidate service affiliate staff to access the necessary information to review the auction details. This website will be properly formatted (WAP, etc) for viewing on a wide array of mobile phones. Also, one embodiment of the invention includes a telephone number in the notification SMS that a candidate service affiliate staff member can dial to hear an integrated voice response menu that describes the opportunity.

The software may also enable the staff member to place bids and otherwise participate in the auction via a typical cell phone. Still another embodiment would allow the staff member to tell the automated system his current location. The automated system would compute the expected travel time to the scene, using live traffic reports, and send the staff member an SMS with detailed directions. Finally, another embodiment of the invention notifies candidate affiliates through an IVR application delivered to any phone line.

Step 5

The platform will next execute the auction process 114. This entails giving candidates the ability to place bids, to see the current bid and to place new bids. The platform will also be capable of computing the time duration of the auction and displaying this information to the set of bidders. Bids may be placed on the web via the web-portal application, via mobile phone or via an Integrated Voice Response (IVR) system using a traditional landline phone. The platform will coordinate the dynamic auction information and disseminate it to bidders accessing the system via any method, including the above-mentioned methods.

The platform will enable data consistency and accuracy across these multiple platforms. Bidders will be notified of the remaining time to place a bid and the dollar value of the current winning bid.

Implementation

Dutch Reverse Auction

Implementing Dutch reverse auctions may require different procedures than that of English auctions. Dutch auctions may be concluded by the submission of the first bid. For example, in a Dutch auction the market-maker would announce a set price (often low) to the candidate affiliates, and the first affiliate to respond by accepting the set price will win the business. In this case the auction execution requires reliable and timely delivery of bidding information. Therefore, the platform will ensure that all communications involving bids are delivered with the highest degree of reliability and timeliness.

Dutch reverse auctions also do not require that auction participants be made aware of other participant's bids. The Dutch reverse auction can be thought of as a yes or no proposition put to each of the candidate service affiliates. The first candidate service affiliate to answer yes (accept the price) wins the business. In this case, the non-winning participants only need to be notified that they did not win the auction.

One implementation of the invention would close the bidding process once an affiliate accepted a Dutch reverse auction. In this embodiment, when a subsequent affiliate was directed to the bidding web-portal, they would be presented with a notice that bidding was closed. Another embodiment of the invention allows the system to prioritize the candidate service affiliates and determine which subset will be contacted first, and thus have an advantageous bidding position. This capability could be used by the market-maker to tier their local service provider affiliates, extract additional revenue or encourage local affiliate behavior.

English Reverse Auction

Implementing English reverse auctions requires more consideration and maintenance of state. In such auctions bidders compete with one another for a predefined period of time or until a pre-defined bid is reached. In these cases, the platform will support the data consistency and state necessary to execute the auction, even over multiple access platforms such as web, wireless and landline.

Settlements and Billing

At the conclusion of the auction 116, the platform will perform auction settlement with the winning bidder 118. This will include finalizing a service contract that binds the winning affiliate to the terms agreed to in the auction.

In addition, fulfillment software on the platform will deliver a work order to the winning bidder that displays all the critical information relevant to the customer and the request. The work order may be delivered electronically or via fax. The platform will log these transactions and archive them. With the work order, the winning affiliate is now free to service the customer's request.

Billing and reconciliation software on the platform will ensure that transactions are billed appropriately and that disputes can be handled. For example, each work order will be logged and identified by the system and will be referenceable from the customer receipt. This will allow easy retrieval of billing documents that can expedite claims.

Quality Assurance and Control

The platform also allows both the customer as well as the winning affiliate to submit feedback on the transaction. For example, a customer may complain of discourteous and/or dangerous drivers.

This information will be logged by the system and used in making future candidate selections and auction decisions. As another example, the winning affiliate may comment that the customer misrepresented their situation, demanded unreasonable service or was otherwise difficult. This information, too, will be stored by the system and can be used in future service decisions.

Customers will be able to access the system via a web-link presented on all customer receipts. This will help to grow the community of comments. Furthermore, one embodiment of this invention allows customers who are requesting service to consult a list of rankings and comments of local service affiliates and suggest a preferred affiliate, possible for a premium fee.

While there has been described and illustrated a system and method for enabling service providers to create real time reverse auctions and several modifications and variations thereof, it will be apparent to those skilled in the art that further modifications and variations are possible without deviating from the teachings and broad principles of the invention which shall be limited solely by the scope of the claims appended hereto.

What is claimed is:

1. A method of enabling service providers to create real-time reverse auctions for location based services comprising the steps of:
determining a location where service is requested;
providing details of the requested service;
identifying service affiliates capable of providing the requested service;
notifying identified service affiliates of an opportunity to bid in an auction;
providing auction related information to bidding service affiliates;
executing the auction;
notifying the winning bidder; and
settling with the winning bidder.

2. A method as set forth in claim 1, where said determining a location includes automatically determining the location.

3. A method as set forth in claim 2, where said automatically determining is selected from the group consisting of cellular positioning, reverse phone number addressing and GPS data.

4. A method as set forth in claim 1, wherein said providing details includes capturing and indexing the details into a networked software platform.

5. A method as set forth in claim 4, wherein said captured and indexed details are in a common format.

6. A method as set forth in claim 1, further comprising supplementing the details with previously captured information.

7. A method as set forth in claim 1, further comprising restricting the service affiliates based on policies.

8. A method as set forth in claim 1, further comprising obtaining real-time traffic conditions and planning a route to the determined location.

9. A method as set forth in claim 1, further comprising identifying service affiliates based on affiliation, facilities, or capabilities.

10. A method as set forth in claim 1, further comprising identifying service affiliates based on customer feedback.

11. A method as set forth in claim 1, wherein said notifying identified service affiliates is via web-based application.

12. A method as set forth in claim 1, wherein said notifying identified service affiliates is via wireless communication.

13. A method as set forth in claim 1, wherein said notifying identified service affiliates is via SMS messaging.

14. A method as set forth in claim 1, wherein said executing the auction is via web-portal application.

15. A method as set forth in claim 1, wherein said executing the auction is via mobile device.

16. A method as set forth in claim 1, wherein said executing the auction is via Integrated Voice Response.

17. A method as set forth in claim 1, wherein said auction is a Dutch reverse auction.

18. A method as set forth in claim 1, wherein said auction is an English reverse auction.

19. A method as set forth in claim 1, further comprising prioritizing service affiliates based on predetermined criteria.

20. A method as set forth in claim 1, further comprising providing feedback on the transaction.

21. A method as set forth in claim 1, further comprising a customer notifying a match-maker of a service request.

22. A system for enabling service providers to create real-time reverse auctions for location based services comprising:
means for determining a location where service is requested;
means for receiving details of the requested service;
means for identifying service affiliates capable of providing the requested service;
notification means for notifying identified service affiliates of an opportunity to bid in an auction;
means for providing auction related information to bidding service affiliates;
a platform for executing the auction;
means for notifying the winning bidder; and
means for settling with the winning bidder.

23. A method as set forth in claim 22, where said means for determining a location comprises means for automatically determining the location.

24. A method as set forth in claim 23, where said means for automatically determining a location is selected from the group consisting of cellular positioning means, reverse phone number addressing means and GPS.

25. A method as set forth in claim 22, wherein said means for receiving details comprises a networked software platform for capturing and indexing the details.

26. A method as set forth in claim 25, wherein said captured and indexed details are in a common format.

27. A method as set forth in claim 25, said networked software platform supplementing the details with previously captured information.

28. A method as set forth in claim 22, said means for identifying service affiliates restricting service affiliates based on policies.

29. A method as set forth in claim 22, further comprising means for obtaining real-time traffic conditions and planning a route to the determined location.

30. A method as set forth in claim 22, said means for identifying service affiliates identifying based on affiliation, facilities, or capabilities.

31. A method as set forth in claim 22, said means for identifying service affiliates identifying based on customer feedback.

32. A method as set forth in claim 22, wherein said notification means comprises a web-based application.

33. A method as set forth in claim 22, wherein said notification means comprises wireless communication device.

34. A method as set forth in claim 22, wherein said notification means comprises SMS messaging means.

35. A method as set forth in claim 22, wherein said platform comprises a web-portal application for executing the auction.

36. A method as set forth in claim 22, wherein said platform comprises a mobile device for executing the auction.

37. A method as set forth in claim 22, wherein said platform comprises Integrated Voice Response means for executing the auction.

38. A method as set forth in claim 22, wherein said platform executes the auction by a Dutch reverse auction.

39. A method as set forth in claim 22, wherein said platform executes the auction by an English reverse auction.

40. A method as set forth in claim 22, wherein said means for identifying prioritizes service affiliates based on predetermined criteria.

41. A method as set forth in claim 22, further comprising means for receiving feedback on the transaction.

42. A method as set forth in claim 22, further comprising means for enabling a customer to notify a match-maker of a service request.
